(19) United States
(12) Patent Application Publication
(10) Pub. No.: US 2020/0023637 A1
(43) Pub. Date: Jan. 23, 2020

(54) HEATER AND INKJET PRINTER

(71) Applicant: Konica Minolta, Inc., Tokyo (JP)

(72) Inventors: Yasuhiro ISHIHARA, Toyohashi-shi (JP); Yuhei TATSUMOTO, Toyokawa-shi (JP); Toshikazu HIGASHI, Toyokawa-shi (JP); Makoto SHIMAZOE, Toyokawa-shi (JP)

(21) Appl. No.: 16/502,889

(22) Filed: Jul. 3, 2019

(30) Foreign Application Priority Data
Jul. 17, 2018 (JP) 2018-133980

(51) Int. Cl. B41J 2/045; H05B 3/20; H05B 3/02; B41J 2/125; G05D 23/24; G05D 23/19

(52) U.S. Cl. CPC B41J 2/04563; H05B 3/20; H05B 3/02; H05B 2214/00; G05D 23/24; G05D 23/1927; B41J 2/125

(57) ABSTRACT

A heater includes: a planar heat generator; a power supply circuit that controls supply of power to the planar heat generator; a plurality of temperature sensors that is provided on the planar heat generator and measures a temperature; and a hardware processor that controls the power supply circuit in a predetermined condition to maintain a temperature measured by at least one of the plurality of temperature sensors at a target value, wherein the planar heat generator includes: an insulator; and a heat generator disposed on the insulator, the heat generator includes each of a plurality of linear parts extending in parallel with each other at a predetermined interval P, and each of the plurality of temperature sensors is disposed along a direction orthogonal to an extending direction of each of the plurality of linear parts at a position mutually shifted by a predetermined distance D.

The entire disclosure of Japanese patent Application No. 2018-133980, filed on Jul. 17, 2018, is incorporated herein by reference in its entirety.

### BACKGROUND

### Technological Field

The present invention relates to a heater and an inkjet printer. More particularly, the present invention relates to a heater and an inkjet printer capable of improving accuracy of temperature control of a planar heat generator.

### Description of the Related Art

An inkjet printer is a printer that ejects small ink droplets from fine nozzles and causes them to fly and to attach to a recording medium, thereby performing printing. The inkjet printer has an advantage of being capable of printing high resolution, high quality images at high speed in a relatively inexpensive manner.

Some inkjet printers use a UV ink (ultraviolet curable ink) as ink. An inkjet printer using the UV ink conveys the UV ink stored in an ink tank to an inkjet head through an ink carriage, and ejects it from the inkjet head.

In general, while the UV ink is gelled and has high viscosity at normal temperature (about 25° C.), it is subject to solation and its viscosity is significantly reduced when heated to about 85° C. Accordingly, at the time of passing through the ink carriage, the UV ink is heated to about 85° C. to enter the state with low viscosity. In order to obtain high image quality, it is necessary to control the ejection amount of the UV ink from the inkjet head with high accuracy. In order to control the ejection amount of the UV ink with high accuracy, the temperature of the UV ink is highly accurately controlled in the ink carriage, thereby stabilizing the viscosity of the UV ink.

As a configuration for heating the UV ink, the ink carriage is attached with a planar heat generator such as a rubber heater. The rubber heater heats the UV ink by conducting heat to the ink through the ink carriage made of metal or the like.

The rubber heater includes a rubber sheet made of silicone or the like, and a heat generator (conductor) made of a nichrome wire or the like provided in the rubber sheet. The heat generator generates heat when power is supplied. The power density of the rubber heater for heating ink (about 1 W/cm²) is higher than the power density of a general rubber heater (about 0.6 W/cm²). Accordingly, the rubber heater for heating ink may have a risk that it becomes high temperature to the temperature at which the rubber heater emits smoke and takes fire. In order to avoid such a situation, in the rubber heater for heating ink, the surface temperature of the rubber heater is measured by a thermistor, and power supplied to the rubber heater is controlled using a thyristor such that the temperature measured by the thermistor becomes a target temperature (about 85° C.).

Note that conventional heaters are disclosed in, for example, JP 2002-117958 A, and JP 2006-127886 A. JP 2002-117958 A discloses a planar heat generator in which a thermostat is disposed close to a portion at which a lead wire is pulled out from a metallic thin film and the thermostat and the lead wire are filled and covered with an insulating resin.

JP 2006-127886 A discloses a heater provided with a heat generating area having the characteristics same as those of a planar heat generator for temperature measurement separately from a heat generating area of the planar heat generator.

In general, a heat generator in a rubber heater has a meandering planar shape, and includes a plurality of linear parts extending in parallel with each other at a predetermined interval, and a connection end part for connecting adjacent linear parts at the end of the linear part. Accordingly, temperature distribution in the surface of the rubber heater tends to be non-uniform. That is, while the temperature is high at a position on the heat generator in the rubber heater, the temperature tends to be low at a position between the linear parts. Therefore, in a conventional case, although temperature control of the rubber heater is performed such that the rubber heater becomes a target temperature (e.g., 85° C.), the actual temperature of the rubber heater is different from the target temperature. As a result, there has been a problem that accuracy of temperature control of a planar heat generator is low.

Here, in order to properly control the temperature of the rubber heater, a method of stabilizing a positional relationship between a thermistor and a heat generator in a rubber sheet is also conceivable. However, since the position of the heat generator in the rubber heater varies among products, it has been difficult to stabilize the positional relationship between the thermistor and the heat generator.

The problem that the accuracy of the temperature control of the heater is low has been more noticeable as the power consumption of the heater is higher. In particular, since an industrial printer outputs a large amount of printed matter per day, the industrial printer requires high productivity (operation rate). In order to shorten the warm-up time at the time of supplying power and to improve the printing speed, it is necessary to perform control such that ink used in the industrial printer is heated to a target temperature in a short time. Accordingly, a rubber heater having high power consumption is required for the industrial printer.

Note that the problem that the accuracy of the temperature control of the planar heat generator is low has not been a problem unique to only a rubber heater or an inkjet printer, but has been a problem common to all heaters including a planar heat generator.

### SUMMARY

The present invention is intended to solve the problems described above, and an object thereof is to provide a heater and an inkjet printer capable of improving accuracy of temperature control of a planar heat generator.

To achieve the abovementioned object, according to an aspect of the present invention, a heater reflecting one aspect of the present invention comprises: a planar heat generator; a power supply circuit that controls supply of power to the planar heat generator; a plurality of temperature sensors that is provided on the planar heat generator and measures a temperature; and a hardware processor that controls the power supply circuit in a predetermined condition to maintain a temperature measured by at least one of the plurality of temperature sensors at a target value, wherein the planar heat generator includes: an insulator; and a heat generator disposed on the insulator, the heat generator includes each of a plurality of linear parts extending in parallel with each other at a predetermined interval P, and each of the plurality of temperature sensors is disposed along a direction orthogonal to an extending direction of each of the plurality of linear parts at a position mutually shifted by a predetermined distance D.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a cross-sectional view illustrating a configuration of an inkjet recording apparatus according to an embodiment of the present invention;

FIGS. 2A and 2B are diagrams illustrating a configuration of a head unit;

FIG. 3 is a perspective view illustrating a configuration of an ink heater, which is a perspective view viewed from one direction;

FIG. 4 is a perspective view illustrating the configuration of the ink heater, which is a perspective view viewed from another direction;

FIG. 5 is a plan view illustrating a configuration of a sheet heater and a thermistor;

FIG. 6 is a diagram illustrating a control circuit of the sheet heater in the inkjet recording apparatus;

FIGS. 7A and 7B are diagrams illustrating a positional relationship between a thermistor and a heat generator in a conventional sheet heater;

FIG. 8 is a graph schematically illustrating a relationship between a position along the direction orthogonal to the extending direction of a linear part of the heat generator and a surface temperature of the sheet heater measured at that position;

FIG. 9 is a table illustrating a result of calculation of the average temperature of the entire sheet heater in each of cases C1 and C2 that are comparative examples;

FIG. 10 is an enlarged view of a portion Yin FIG. 5, which is a diagram illustrating a positional relationship between two thermistors THa and THb and a heat generator according to an embodiment of the present invention;

FIG. 11 is a flowchart illustrating control operation of a controller in a case where the controller starts warm-up control in an embodiment of the present invention; and

FIG. 12 is a table illustrating a result of calculation of the average temperature of the entire sheet heater in each of cases C3, C4, and C5 that are examples of the present invention.

### DETAILED DESCRIPTION OF EMBODIMENTS

Hereinafter, one or more embodiments of the present invention will be described with reference to the drawings. However, the scope of the invention is not limited to the disclosed embodiments.

In the following embodiment, a case where an inkjet printer includes a heater will be described. The heater may be included in an apparatus other than the inkjet printer.

[Configuration of Inkjet Recording Apparatus 1]

First, a configuration of an inkjet recording apparatus 1 will be described.

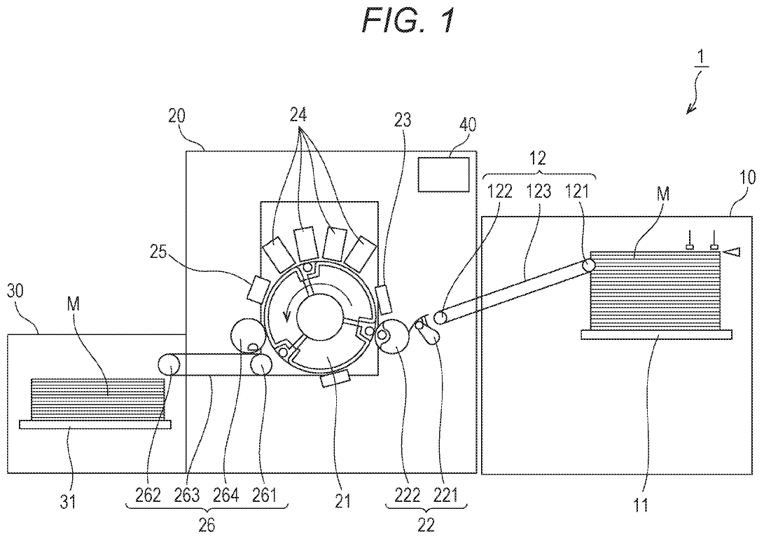

FIG. 1 is a cross-sectional view illustrating the configuration of the inkjet recording apparatus 1 according to an embodiment of the present invention.

Referring to FIG. 1, the inkjet recording apparatus 1 (example of the heater and the inkjet printer) according to the present embodiment includes a sheet feeder 10, an image former 20, a sheet ejector 30, and a controller 40 (example of a control unit and a setting unit). The inkjet recording apparatus 1 conveys a recording medium M from the sheet feeder 10 to the image former 20 under the control of the controller 40, forms an image on the conveyed recording medium M using the image former 20, and ejects the recording medium M bearing the formed image to the sheet ejector 30.

The sheet feeder 10 holds the recording medium M on which an image is to be formed, and supplies it to the image former 20 before the image is formed. The sheet feeder 10 includes a sheet feed tray 11, and a conveyer 12.

The sheet feed tray 11 is tabular, and is capable of placing one or more recording media M thereon. The sheet feed tray 11 moves up and down according to the placed amount of the recording medium M. The sheet feed tray 11 is held at the position at which the uppermost recording medium M is conveyed by the conveyer 12.

The conveyer 12 includes a plurality of (two, in this case) rollers 121 and 122, and an annular belt 123. The belt 123 is rotationally driven by the plurality of rollers 121 and 122. The conveyer 12 includes a conveyance mechanism for conveying the recording medium M on the belt 123, and a supply unit for delivering the uppermost recording medium M placed on the sheet feed tray 11 to the belt 123. The conveyer 12 conveys, as the belt 123 rotates, the recording medium M delivered to the belt 123 by the supply unit.

The image former 20 ejects ink including the UV ink or the like onto the recording medium M to form an image on the recording medium M. The image former 20 includes an image forming drum 21, a handover unit 22, a sheet heating unit 23, a plurality of head units 24, an irradiator 25, and a delivery unit 26.

The image forming drum 21 supports the recording medium M along the cylindrical outer peripheral surface, and conveys the recording medium M as it rotates. The conveyance surface of the image forming drum 21 faces the sheet heating unit 23, the plurality of head units 24, and the irradiator 25. The image forming drum 21 performs, on the recording medium M to be conveyed, processing related to image formation.

The handover unit 22 is provided between the conveyer 12 of the sheet feeder 10 and the image forming drum 21. The handover unit 22 delivers the recording medium M conveyed by the conveyer 12 to the image forming drum 21. The handover unit 22 includes a swing arm 221, a cylindrical delivery drum 222, and the like. The swing arm 221 supports one end of the recording medium M conveyed by the conveyer 12. The delivery drum 222 delivers the recording medium M supported by the swing arm 221 to the image forming drum 21. The handover unit 22 picks up the recording medium M on the conveyer 12 using the swing arm 221 to deliver it to the delivery drum 222, whereby the recording medium M is guided along the outer peripheral surface of the image forming drum 21 and is delivered to the image forming drum 21.

The sheet heating unit 23 heats the recording medium M supported by the image forming drum 21. The sheet heating unit 23 includes, for example, an infrared heater, and generates heat in response to energization. The sheet heating unit 23 is provided in the vicinity of the outer peripheral surface of the image forming drum 21, which is on the upstream side of the head units 24 along the conveyance direction of the recording medium M based on the rotation of the image forming drum 21. The heat generation of the sheet heating unit 23 is controlled by the controller 40 such that, the recording medium M supported by the image forming drum 21, which passes near the sheet heating unit 23, is made to have a predetermined temperature.

The plurality of head units 24 ejects ink of each color of cyan (C), magenta (M), yellow (Y), and black (K) onto the recording medium M supported by the image forming drum 21, thereby forming an image on the recording medium M. The head unit 24 is individually provided for each of the colors C, M, Y, and K. In FIG. 1, the head units 24 corresponding to the respective colors Y, M, C, and K are provided in that order along the conveyance direction of the recording medium M, which is conveyed as the image forming drum 21 rotates.

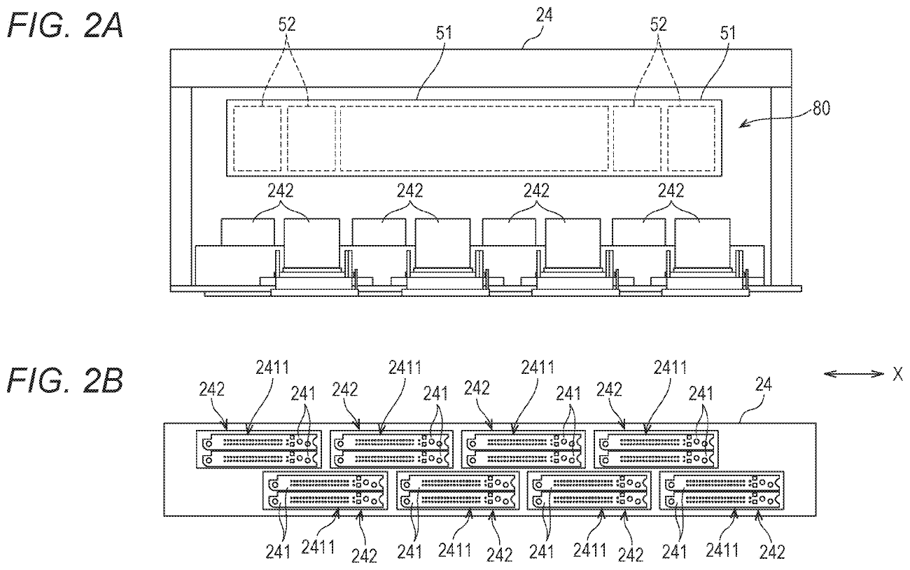

Note that the head unit 24 according to the present embodiment has a length (width) that covers the entire recording medium M in a direction (width direction) perpendicular to the conveyance direction of the recording medium M. In other words, the inkjet recording apparatus 1 is a line-head inkjet recording apparatus of a one-pass system. The head unit 24 is capable of forming a line head by arranging a plurality of inkjet heads 241 (FIGS. 2A and 2B). An internal configuration of the head unit 24 will be described later.

After the ink used in the inkjet recording apparatus 1 according to the present embodiment is ejected onto the recording medium M, the irradiator 25 emits an energy ray for curing the ink. The irradiator 25 includes a fluorescent tube such as a low pressure mercury lamp, for example, and emits an energy ray such as an ultraviolet ray by causing the fluorescent tube to emit light. The irradiator 25 is provided in the vicinity of the outer peripheral surface of the image forming drum 21, which is on the downstream side of the head units 24 with respect to the conveyance direction of the recording medium M based on the rotation of the image forming drum 21. The irradiator 25 irradiates, with an energy ray, the recording medium M supported by the image forming drum 21 and on which the ink is ejected, thereby curing the ink ejected onto the recording medium M on the basis of the action of the energy ray.

Examples of the fluorescent tube include, in addition to the low pressure mercury lamp, a mercury lamp having an operation pressure of about several hundred Pa to 1 MPa, a light source that can be used as a germicidal lamp, a cold-cathode tube, an ultraviolet laser light source, a metal halide lamp, and a light-emitting diode. It is more preferable to employ a light source capable of emitting ultraviolet rays with higher illuminance and consuming less power (e.g., light-emitting diode) among them. Further, the energy ray is not limited to the ultraviolet ray, and may be any energy ray having the property of curing ink according to the property of the ink, and the light source may be replaced depending on the wavelength of the energy ray or the like.

The delivery unit 26 conveys the recording medium M irradiated with the energy ray by the irradiator 25 from the image forming drum 21 to the sheet ejector 30. The delivery unit 26 includes a plurality of (two, in this case) rollers 261 and 262, an annular belt 263, and the like. The belt 263 is rotationally driven by the plurality of rollers 261 and 262. The delivery unit 26 includes a conveyance mechanism for conveying the recording medium M on the belt 263, and a cylindrical delivery drum 264 for delivering the recording medium M from the image forming drum 21 to the conveyance mechanism. The delivery unit 26 conveys, using the belt 263, the recording medium M delivered to the belt 263 by the delivery drum 264, and delivers it to the sheet ejector 30.

The sheet ejector 30 stores the recording medium M delivered from the image former 20 by the delivery unit 26. The sheet ejector 30 includes a tabular sheet ejection tray 31 and the like, and places the recording medium M having been subject to the image formation on the sheet ejection tray 31.

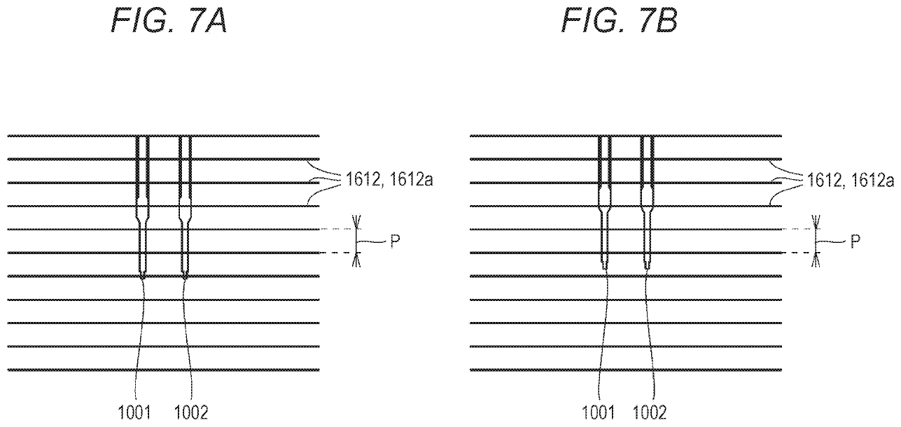

The controller 40 controls operation of each unit of the inkjet recording apparatus 1, and performs centralized control on the entire operation. The controller 40 includes a central processing unit (CPU) 41 (FIGS. 7A and 7B), a read-only memory (ROM), a random access memory (RAM), and the like. The controller 40 reads out various processing programs, such as a system program, stored in the ROM, loads them in the RAM, and causes the CPU 41 to execute the programs loaded in the RAM.

The ink used in the inkjet recording apparatus 1 includes, for example, a UV ink. The UV ink undergoes, in the state of not being irradiated with the UV, a change of phase between the gel state and the liquid (sol) state depending on the temperature. The UV ink has a phase change temperature of, for example, about 100° C., and is uniformly liquefied (subject to solation) when heated to a temperature equal to or higher than the phase change temperature. Meanwhile, this ink gelates at a temperature equal to or lower than the phase change temperature including normal ambient temperature (0° C. to 30° C.).

Next, a configuration of one head unit 24 out of the plurality of head units 24 will be described.

FIGS. 2A and 2B are diagrams illustrating the configuration of the head unit 24. FIG. 2A is a front view, and FIG. 2B is a bottom view. Note that, in the drawing, the longitudinal direction of the head unit 24 is regarded as an X direction, the direction along the ink ejection direction of the head unit 24 provided with the ink heater 80 is regarded as a Z direction, and the direction orthogonal to the X direction and the Z direction is regarded as a Y direction.

Referring to FIGS. 2A and 2B, the head unit 24 includes the plurality of inkjet heads 241, and the ink heater 80. Here, one head unit 24 includes 16 inkjet heads 241. The 16 inkjet heads 241 constitutes eight inkjet modules 242 with each two inkjet heads 241 being paired.

Referring to FIG. 2B, each of the inkjet heads 241 includes a plurality of nozzles 2411. When one inkjet head 241 is focused, the plurality of nozzles 2411 is exposed on the lower surface side of the head unit 24, and is configured by two rows extending in the X direction. The inkjet head 241 ejects ink from the plurality of nozzles 2411 to form an image on the recording medium M supported by the image forming drum 21.

As illustrated in FIG. 2B, the eight inkjet modules 242 are configured in two rows extending in the X direction. Each of the eight inkjet modules 242 is disposed zigzag in the two rows with respect to the direction orthogonal to the X direction.

As described above, in order to stabilize the fluidity of the ink in an ink tank 50 and the ink ejection amount in the head, the ink heater 80 heats the ink so that the ink in the gel state at about the ambient temperature enters the liquid (sol) state, and supplies the heated ink to each of the plurality of inkjet heads 241.

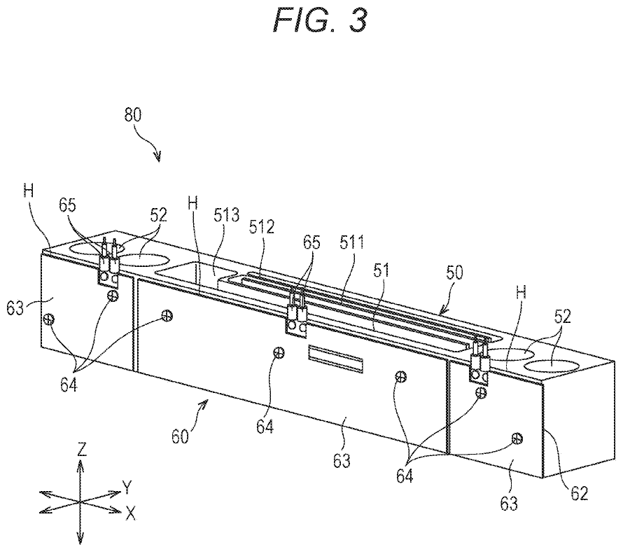

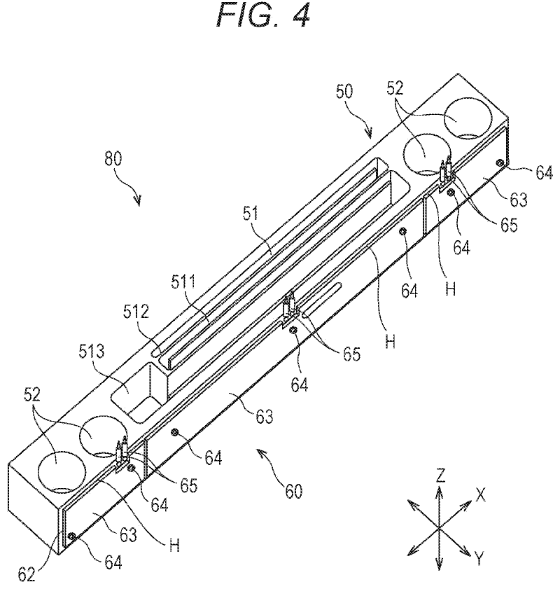

FIGS. 3 and 4 are perspective views illustrating a configuration of the ink heater 80. FIG. 3 is a perspective view viewed from one direction, and FIG. 4 is a perspective view viewed from another direction different from one direction.

Referring to FIGS. 3 and 4, the ink heater 80 includes the ink tank 50 (exemplary ink holder), and an ink tank heater 60. The ink tank 50 is formed in such a manner that a plurality of sub tanks for storing ink is arranged in the longitudinal direction and is integrally molded. The ink tank heater 60 is provided on the outer surface of the ink tank 50. The ink tank heater 60 heats the ink tank 50.

The ink tank 50 stores ink supplied from an ink storage unit (not illustrated), and supplies the stored ink to the inkjet head 241. Further, the ink tank 50 collects and stores the ink that has not been ejected from the inkjet head 241. The ink tank 50 is formed to be long in the X direction, and includes a first sub tank 51 and four second sub tanks 52 integrally molded. The first sub tank 51 and the second sub tank 52 are arranged along the longitudinal direction (X direction) of the ink tank 50.

The first sub tank 51 is provided in a recessed manner at the center of the ink tank 50 in the longitudinal direction (X direction). The first sub tank 51 stores the ink supplied from an ink supply unit (not illustrated), and also stores the ink collected from the inkjet head 241.

The first sub tank 51 includes a flow path 511, an inflow portion 512, and a reservoir 513. The flow path 511 is for causing the supplied ink to flow. The inflow portion 512 is provided at one end of the flow path 511. The inflow portion 512 is a portion into which the ink supplied or collected from the ink supply unit or the inkjet head 241 flows. The reservoir 513 is provided at the other end of the flow path 511. The reservoir 513 is a portion that stores the ink having passed through the flow path 511 and supplies the ink to the second sub tank 52.

In other words, the ink supplied from the inflow portion 512 passes through the flow path 511, and is stored in the reservoir 513. The ink that has reached the reservoir 513 is delivered to the plurality of second sub tanks 52 by a plurality of pumps (not illustrated).

The second sub tanks 52 are provided two by two on both ends of the ink tank 50 in the longitudinal direction (X direction) in a recessed manner. The second sub tank 52 stores the ink supplied from the first sub tank 51. The ink stored in each of the second sub tanks 52 is supplied to each of the eight inkjet modules 242 provided in the head unit 24.

The ink tank heater 60 covers the entire one side surface of the ink tank 50. The ink tank heater 60 includes a sheet heater H (exemplary planar heat generator), an elastic member 62, a metallic plate 63, a fixing screw 64, and a thermistor 65. The sheet heater H is provided on the outer surface of the ink tank 50, and heats the ink tank 50. The elastic member 62 is sandwiched between the sheet heater H and the metallic plate 63. The metallic plate 63 is tabular, and is provided on the surface of the sheet heater H on the side opposite to the side facing the ink tank 50. The fixing screw 64 presses and fixes the metallic plate 63 to the side of the ink tank 50. The thermistor 65 is in contact with the sheet heater H.

The sheet heater H, the elastic member 62, the metallic plate 63, the fixing screw 64, and the thermistor 65 are separately provided at three portions of the center and the both ends of the ink tank 50 in the longitudinal direction. The sheet heater H and the like separately provided in the three portions are disposed at positions corresponding to the first sub tank 51 provided at the center of the ink tank 50 in the longitudinal direction (X direction) and the second sub tanks 52 provided at the both ends of the ink tank 50 in the longitudinal direction (X direction), respectively.

The controller 40 performs thermostatic control on the sheet heater H such that the temperature measured by the thermistor 65 becomes a target value Ti in a predetermined condition (in this case, condition in which the sheet heater H shifts to an idling mode).

Note that the inkjet recording apparatus 1 includes the head units 24 corresponding to the colors of Y, M, C, and K, and each of the plurality of head units 24 includes the ink tank 50. Therefore, the inkjet recording apparatus 1 includes a plurality of ink tanks 50 for holding each of the inks of a plurality of different colors (each of the colors Y, M, C, and K).

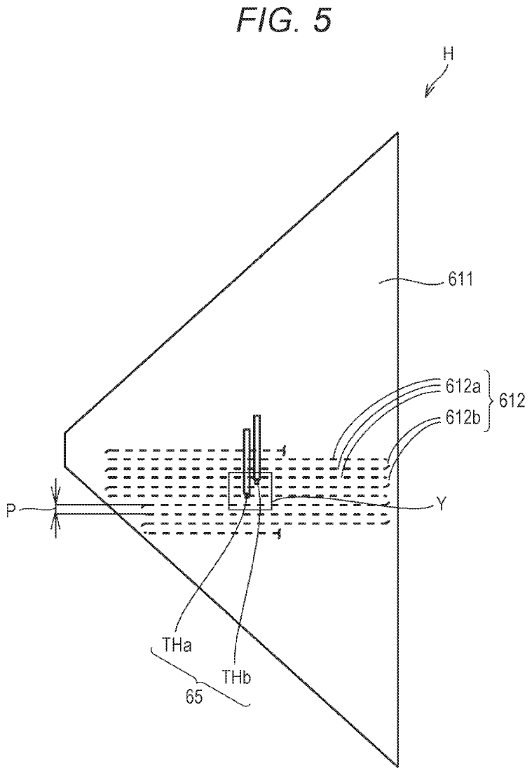

FIG. 5 is a plan view illustrating a configuration of the sheet heater H and the thermistor 65. Note that only a part of a heat generator 612 is illustrated in FIG. 5.

Referring to FIG. 5, the sheet heater H includes an insulator 611 (exemplary insulator), and the heat generator 612 (exemplary heat generator). The insulator 611 includes a rubber sheet made of silicone or the like. The insulator 611 has an arbitrary planar shape, and in this case, it has a planar shape that is substantially triangular.

The heat generator 612 is provided in the insulator 611, and is embedded in the entire insulator 611. The heat generator 612 is disposed in the insulator 611 in a corrugated manner, and has a meandering planar shape. The heat generator 612 includes a nichrome wire or stainless steel (SUS thin film formed by etching), or the like.

The heat generator 612 includes a plurality of linear parts 612a (exemplary linear part), and a plurality of connection end parts 612b. Each of the plurality of linear parts 612a extends in parallel with each other at a predetermined interval P (hereinafter also referred to as heat generator interval P) to obtain target power density per unit area. Each of the plurality of connection end parts 612b has an arc shape, and connects two adjacent linear parts 612a at the end of the linear part 612a.

The thermistor 65 includes thermistors THa and THb (exemplary temperature sensor). The thermistors THa and THb are of contact-type, and are provided at predetermined positions on the sheet heater H. The thermistors THa and THb function as a plurality of temperature sensors that measures a surface temperature of the sheet heater H. Note that a thermocouple may be used as a temperature sensor instead of the thermistor.

The thermistors THa and THb are provided close to each other in pairs for one sheet heater H. One of the thermistors THa and THb is a thermistor for thermostatic control. That is, in a predetermined condition, the controller 40 maintains the temperature measured by the thermistor for thermostatic control at a predetermined target value Ti.

The other one of the thermistors THa and THb is a thermistor for abnormality detection (for safety protection in an emergency). That is, the controller 40 monitors the difference between the temperature measured by the thermistor for abnormality detection and the temperature measured by the thermistor for thermostatic control, and determines that the thermistor is abnormal when the difference in temperature becomes equal to or more than a threshold value. The abnormality of the thermistor assumed in this case is an error in attachment of the thermistor, a mixture of foreign matter between the heater and the contact, a manufacturing failure of the thermistor itself, or the like.

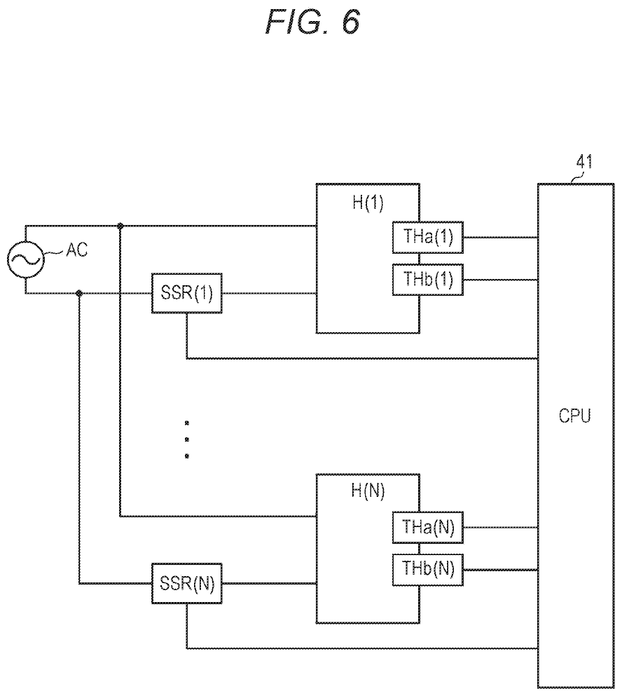

FIG. 6 is a diagram illustrating a control circuit of the sheet heater H in the inkjet recording apparatus 1.

Referring to FIG. 6, the inkjet recording apparatus 1 further includes a plurality of thyristors SSR (exemplary power supply circuit). Each of the plurality of thyristors SSR is connected between an alternating-current power supply AC and each of the plurality of sheet heaters H, and controls the supply of power to each of the plurality of sheet heaters H.

Here, the inkjet recording apparatus 1 includes N (N is a natural number) sheet heaters H. Each of the N sheet heaters H is denoted by a sheet heater H(1), a sheet heater H(2), a sheet heater H(3), and so on, and a sheet heater H(N). In addition, the thermistors THa and THb corresponding to each of the sheet heaters H(1) to H(N) are denoted by thermistors THa(1) and THb(1), thermistors THa(2) and THb(2), thermistors THa(3) and THb(3), and so on, and thermistors THa(N) and THb(N), respectively. Furthermore, the thyristors SSR corresponding to the respective sheet heaters H(1) to H(N) are denoted by a thyristor SSR(1), a thyristor SSR(2), a thyristor SSR(3), and so on, and a thyristor SSR(N), respectively.

Here, one sheet heater H(1) is focused. The CPU 41 of the controller 40 controls on/off of the thyristor SSR(1) in a predetermined condition, thereby controlling energization of the heat generator 612 of the sheet heater H(1) using the thyristor SSR(1). As a result, the CPU 41 maintains the temperature measured by the thermistor for thermostatic control among the thermistors THa(1) and THb(1) at the target value Ti.

Note that, as illustrated in FIG. 1, the inkjet recording apparatus 1 according to the present embodiment includes four head units 24 corresponding to the respective colors Y, M, C, and K. As illustrated in FIG. 2B, one head unit 24 includes one ink tank 50. As illustrated in FIGS. 3 and 4, one ink tank 50 includes three sheet heaters H. One sheet heater H includes one thyristor SSR, and two thermistors THa and THb. Therefore, the value of N in the present embodiment is 12 (=4×1×3). The value of N may be one, or two or more.

[Positional Relationship Between Two Thermistors and Heat Generator]

Referring to FIG. 5, the thermistors THa and THb are attached to the sheet heater H having been complete at predetermined positions determined on the basis of dimensions of the sheet heater H. However, the position of the heat generator 612 varies among the products of the sheet heater H.

Moreover, since the heat generator 612 is provided inside the insulator 611 at the time of attaching the thermistors THa and THb, it is difficult to visually confirm the position of the heat generator 612 from the surface (surface appearance) of the sheet heater H. For that reason, the positions at which the thermistors THa and THb are attached vary among the products of the sheet heater H. As a result, there are variations among the products of the sheet heater H in the relationship between the positions of the thermistors THa and THb and the position of the heat generator 612.

FIGS. 7A and 7B are diagrams illustrating a positional relationship between a thermistor and a heat generator in a conventional sheet heater.

Referring to FIGS. 7A and 7B, conventional thermistors 1001 and 1002 are disposed at the same position along the direction orthogonal to a linear part 1612a so that the measurement position of the thermistor for thermostatic control is made coincident with the measurement position of the thermistor for abnormality detection. As described above, there are variations among the products of the sheet heater in the relationship between the positions of the two thermistors and the position of the heat generator. Therefore, conventionally, the two thermistors 1001 and 1002 may be disposed on the linear part 1612a of a heat generator 1612 as illustrated in a case C1 of FIG. 7A, or the two thermistors 1001 and 1002 may be disposed between two linear parts 1612a of the heat generator 1612 as illustrated in a case C2 of FIG. 7B, even if the sheet heater H has the same specifications.

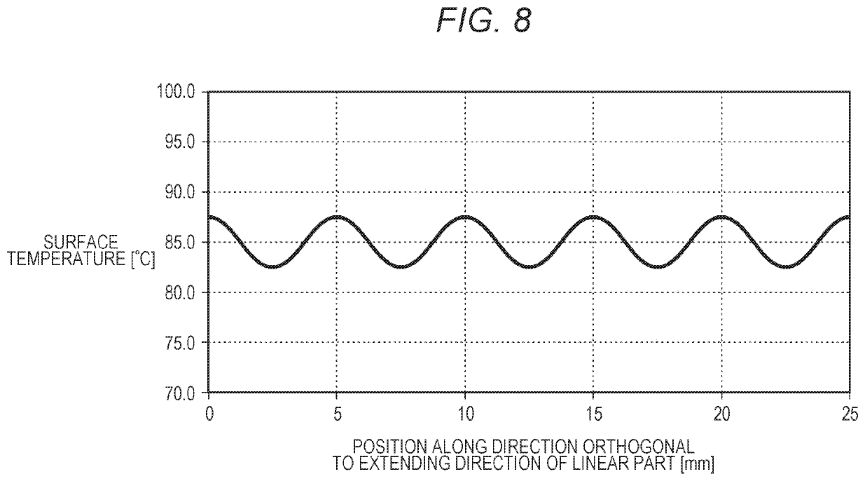

FIG. 8 is a graph schematically illustrating a relationship between a position along the direction orthogonal to the extending direction of the linear part of the heat generator and a surface temperature of the sheet heater measured at that position.

Referring to FIG. 8, the sheet heater has a mechanism in which the heat generator is energized to generate resistive heat so that the heat is transferred to the entire insulator and the entire sheet heater generates heat. Accordingly, there is a difference in temperature between the position on the linear part of the heat generator and the position between the linear parts. For example, in a case where power is supplied to the sheet heater in which the pitch of the linear parts of the heat generator is 5 mm at a target temperature of 85° C., the temperature becomes locally high at the position on the linear part, and the temperature becomes locally low at the position between the linear parts. As a result, a difference in temperature (unevenness in temperature) of up to about 5° C. occurs in the temperature measured by the thermistor among the products of the sheet heater.

The present inventors conducted the following experiments to confirm the problems of temperature control using the conventional sheet heater.

The thermistors 1001 and 1002 were disposed as in the case C1 illustrated in FIG. 7A and the case C2 illustrated in FIG. 7B. The thermistor 1001 was initially set to be a thermistor for thermostatic control, and one of the thermistors 1001 and 1002 with a higher measured temperature was switched to the thermistor for thermostatic control at a predetermined timing. Then, energization to the heat generator was controlled such that the temperature measured by the thermistor for thermostatic control became the target temperature (in this case, 85° C.), the temperatures at a plurality of portions of the sheet heater were actually measured, and the average temperature of the entire sheet heater was calculated.

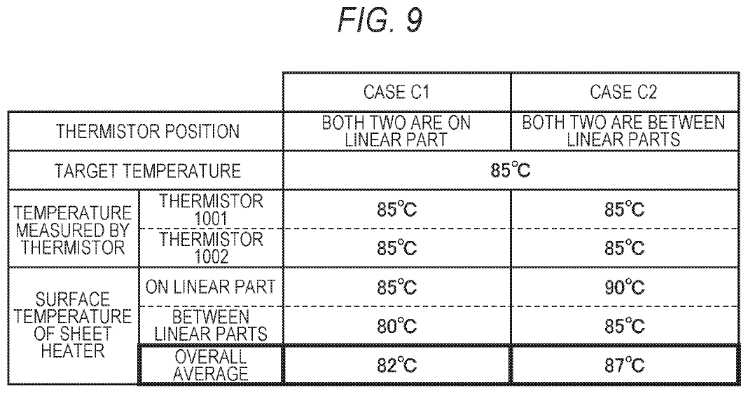

FIG. 9 is a table illustrating a result of the calculation of the average temperature of the entire sheet heater in each of the cases C1 and C2 that are comparative examples.

Referring to FIG. 9, in the case C1, the thermistors 1001 and 1002 measure the temperature at the position where the temperature is locally high in the sheet heater. As a result, the average temperature of the entire sheet heater was 82° C.

Meanwhile, in the case C2, the thermistors 1001 and 1002 measure the temperature at the position where the temperature is locally low in the sheet heater. As a result, the average temperature of the entire sheet heater was 87° C.

In this manner, in the conventional sheet heater, the average temperature of the entire sheet heater under control varied up to about 5° C. due to the variation in the positional relationship between the two thermistors and the heat generator.

In view of the above, in the present embodiment, the positional relationship between the two thermistors and the heat generator is defined as follows.

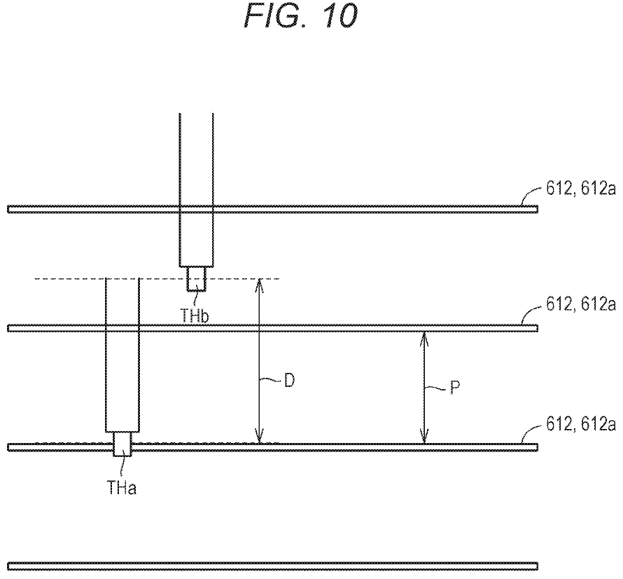

FIG. 10 is an enlarged view of a portion Yin FIG. 5, which is a diagram illustrating the positional relationship between the two thermistors THa and THb and the heat generator 612 according to the embodiment of the present invention.

Referring to FIG. 10, each of the two thermistors THa and THb is disposed along the direction orthogonal to the extending direction of each of the plurality of linear parts 612a in the heat generator 612 (longitudinal direction in FIG. 10) at positions mutually shifted by a predetermined distance D (hereinafter also referred to as inter-thermistor distance D).

Here, when m is a natural number, the relationship expressed by the following formula (1) is preferably established between the heat generator interval P and the inter-thermistor distance D.

D≠P×(m−1) (1)

The formula (1) indicates a condition under which the inter-thermistor distance D does not become an integral multiple of the heat generator interval P. When the relationship expressed by the formula (1) is established, the distance between the thermistor THa and the linear part 612a closest to the thermistor THa can be made different from the distance between the thermistor THb and the linear part 612a closest to the thermistor THb. Accordingly, the difference in temperature measured by the thermistor among the products of the sheet heater can be moderated.

Moreover, in addition to the formula (1), the relationship expressed by the following formula (2) is also preferably established between the heat generator interval P and the inter-thermistor distance D.

0.9×P×(m−½)≤D≤1.1×P×(m−½) (2)

The formula (2) indicates a condition under which the inter-thermistor distance D is approximately an odd multiple of half of the heat generator interval P. When the relationship expressed by the formula (2) is established, the difference between the distance from the thermistor THa to the linear part 612a closest to the thermistor THa and the distance from the thermistor THb to the linear part 612a closest to the thermistor THb can be made larger. Accordingly, the difference in temperature, which is measured by the thermistor, among the products of the sheet heater can be further moderated.

[Flowchart]

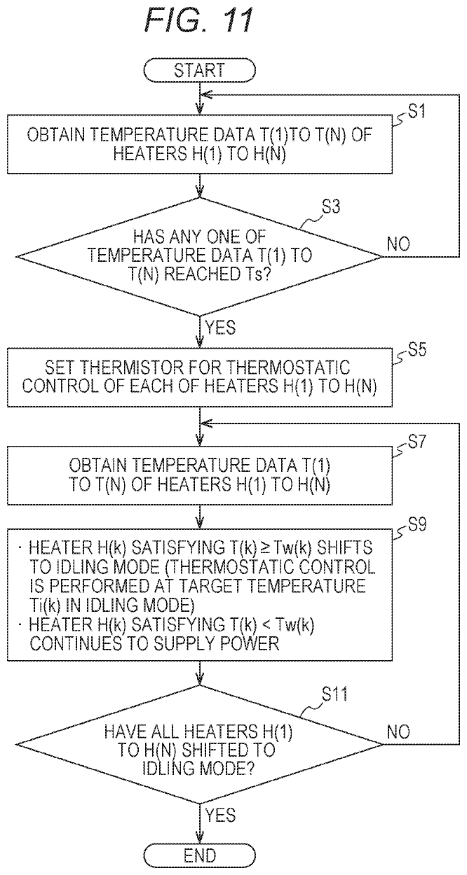

FIG. 11 is a flowchart illustrating control operation of the controller 40 in a case where the controller 40 starts warm-up control in the embodiment of the present invention.

Referring to FIG. 11, when warm-up control (control in the case where the inkjet recording apparatus 1 performs warm-up operation) is started, the controller 40 obtains measured temperature data T(1) to T(N) from, among the respective two thermistors THa and THb of N sheet heaters H(1) to H(N), the thermistor initially set to be a thermistor for thermostatic control (S1). The controller 40 regards the obtained temperature data T(1) to T(N) as surface temperatures of the sheet heaters H(1) to H(N). Next, the controller 40 determines whether any one of the obtained temperature data T(1) to T(N) has reached a first target temperature Ts (S3).

When it is determined that none of the obtained temperature data T(1) to T(N) has reached the first target temperature Ts in step S3 (NO in S3), the controller 40 proceeds to the processing of step S1.

When it is determined that any one of the obtained temperature data T(1) to T(N) has reached the target temperature Ts in step S3 (YES in S3), the controller 40 obtains temperature data also from, among the respective two thermistors THa and THb of N sheet heaters H(1) to H(N), the thermistor initially unset to be a thermistor for thermostatic control. Then, the controller 40 compares the temperature data obtained from each of the two thermistors THa and THb in each of the N sheet heaters H(1) to H(N), and sets the thermistor with higher temperature to be a thermistor for thermostatic control for the heater H (S5).

Note that the thermistor with lower temperature may be set as the thermistor for thermostatic control in step S5. However, from the viewpoint of safely controlling the sheet heater H, the thermistor with higher temperature is preferably set as the thermistor for thermostatic control.

In addition, the timing at which the controller 40 obtains measured temperature data from the thermistor initially unset to be the thermistor for thermostatic control may be the timing of step S5, or may be the timing of step S1 (timing same as the timing at which measured temperature data is obtained from the thermistor initially set to be the thermistor for thermostatic control).

Furthermore, the timing for setting the thermistor for thermostatic control from among the two thermistors THa and THb may be during power supply to the sheet heater H using the thyristor SSR, the timing at which a predetermined period of time has elapsed since the start of the warm-up operation of the inkjet recording apparatus 1, or may be the timing at which at least one of the plurality of sheet heaters H has reached a predetermined temperature as described above.

Next, the controller 40 obtains measured temperature data T(1) to T(N) from, among the respective two thermistors THa and THb of the N sheet heaters H(1) to H(N), the thermistor for thermostatic control (S7). Next, the controller 40 compares each of the measured temperature data T(1) to T(N) with a second target temperature Tw at the time of warm-up, and causes a sheet heater H(k) that satisfies “T(k) (k is an arbitrary natural number of 1 to N)≥Tw(k)” to shift to the idling mode (S9).

With regard to the sheet heater H(k) that has shifted to the idling mode, the controller 40 controls a thyristor SSR(k) such that the temperature measured by the thermistor for thermostatic control for the sheet heater H(k) is maintained at a target value Ti(k) (thermostatic control). Meanwhile, the controller 40 continues to supply power for the sheet heater H(k) that satisfies “T(k)<Tw(k)” in step S9.

Note that each of the first target temperature Ts, the second target temperature Tw, and the target value Ti may have mutually different values or may have the same value in each of the sheet heaters H(1) to H(N).

Subsequently, the controller 40 determines whether all the sheet heaters H(1) to H(N) have shifted to the idling mode (S11).

When it is determined that at least a part of the sheet heaters H(1) to H(N) has not shifted to the idling mode in step S11 (NO in S11), the controller 40 proceeds to the processing of step S7.

When it is determined that all the sheet heaters H(1) to H(N) have shifted to the idling mode in step S11 (YES in S11), the controller 40 completes the warm-up control and terminates the process.

[Effect of Embodiments]

According to the embodiment described above, each of the plurality of thermistors THa and THb for measuring the temperature provided on the sheet heater H is disposed along the direction orthogonal to the extending direction of each of the plurality of linear parts 612a in the heat generator 612 at positions mutually shifted by the predetermined distance D. Accordingly, the distances from each of the plurality of thermistors THa and THb to the closest linear part 612a can be made different from each other. As a result, the difference in temperature measured by the thermistor among the products of the sheet heater H can be moderated, and the accuracy of the temperature control of the sheet heater H can be improved. As a result, image quality of the image formed by the inkjet recording apparatus 1 can be stabilized.

Furthermore, since the accuracy of the temperature control of the sheet heater H can be improved only by changing the position at which each of the plurality of thermistors THa and THb is disposed, it is not necessary to increase the management cost required for suppressing variations among the products of the sheet heater H.

The present inventors conducted the following experiments to confirm the effects described above.

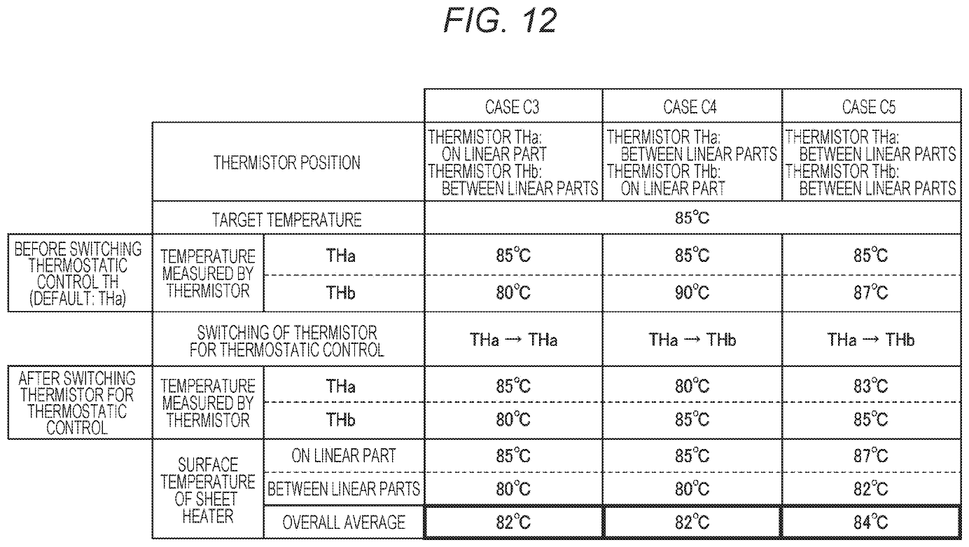

FIG. 12 is a table illustrating a result of the calculation of the average temperature of the entire sheet heater in each of cases C3, C4, and C5 that are examples of the present invention.

Referring to FIG. 12, the thermistors THa and THb were disposed at mutually different positions in the cases C3, C4, and C5. The thermistor THa was initially set to be a thermistor for thermostatic control, and one of the thermistors THa and THb with a higher measured temperature was switched to the thermistor for thermostatic control at a predetermined timing. Then, energization to the heat generator was controlled such that the temperature measured by the thermistor for thermostatic control became the target temperature (in this case, 85° C.), the temperatures at a plurality of portions of the sheet heater were actually measured, and the average temperature of the entire sheet heater was calculated.

In the case C3, the thermistor THa was disposed on the linear part 612a, and the thermistor THb was disposed between the linear parts 612a. In the case C4, the thermistor THa was disposed between the linear parts 612a, and the thermistor THb was disposed on the linear part 612a. In the case C5, both of the thermistors THa and THb were disposed between the linear parts 612a.

In the case C3, since the thermistor THa was disposed on the linear part, the temperature measured by the thermistor THa was higher than the temperature measured by the thermistor THb, and the thermistor THa was set as the thermistor for thermostatic control. As a result, in the case C3, feedback control was performed such that the temperature at the position with a locally high temperature became 85° C., and the average temperature of the entire sheet heater H was 82° C.

In the case C4, since the thermistor THb was disposed on the linear part, the temperature measured by the thermistor THb was higher than the temperature measured by the thermistor THa, and the thermistor THb was set as the thermistor for thermostatic control. As a result, in the case C4, feedback control was performed such that the temperature at the position with a locally high temperature became 85° C., and the average temperature of the entire sheet heater H was 82° C.

In the case C5, since both of the thermistor THa and the thermistor THb were disposed between the linear parts and the temperature measured by the thermistor THb was higher than the temperature measured by the thermistor THa, the thermistor THb was set as the thermistor for thermostatic control. As a result, in the case C5, feedback control was performed such that the temperature at the position with a moderate temperature became 85° C., and the average temperature of the entire sheet heater H was 84° C.

According to the results of the cases C3, C4, and C5, even if there was variation in the positional relationship between the two thermistors and the heat generator, the variation in the average temperature of the entire sheet heater H among the products was suppressed to about 2° C.

[Others]

Instead of using one of the two temperature sensors as a temperature sensor for thermostatic control, a plurality of temperature sensors may be used as the temperature sensor for thermostatic control. In that case, the average value of the temperatures measured by each of the plurality of temperature sensors may be treated as a temperature measured by the temperature sensor for thermostatic control.

The process in the embodiment described above may be performed by software, or may be performed using a hardware circuit. Further, a program for executing the process in the embodiment described above may be provided, or the program may be recorded in recording medium, such as a CD-ROM, a flexible disk, a hard disk, a ROM, a RAM, and a memory card, which is to be provided to a user. The program is executed by a computer such as a CPU. Furthermore, the program may be downloaded to an apparatus via a communication line such as the Internet.

Although embodiments of the present invention have been described and illustrated in detail, it should be considered that the disclosed embodiments are made for purposes of illustration and example only and not limitation in every respect. The scope of the present invention should be interpreted not by the descriptions above but by terms of the appended claims, and it is intended to include all modifications in the meanings equivalent to and within the scope of the claims

What is claimed is:

1. A heater comprising:
a planar heat generator;
a power supply circuit that controls supply of power to the planar heat generator;
a plurality of temperature sensors that is provided on the planar heat generator and measures a temperature; and
a hardware processor that controls the power supply circuit in a predetermined condition to maintain a temperature measured by at least one of the plurality of temperature sensors at a target value, wherein
the planar heat generator includes:
an insulator; and
a heat generator disposed on the insulator,
the heat generator includes
each of a plurality of linear parts extending in parallel with each other at a predetermined interval P, and
each of the plurality of temperature sensors is disposed along a direction orthogonal to an extending direction of each of the plurality of linear parts at a position mutually shifted by a predetermined distance D.

2. The heater according to claim 1, wherein when m is a natural number, a relationship of D≠P×(m−1) is satisfied between the interval P and the distance D.

3. The heater according to claim 2, wherein a relationship of 0.9×P×(m−½)≤D≤1.1×P×(m−½) is further satisfied between the interval P and the distance D.

4. The heater according to claim 1, wherein
the insulator includes silicone rubber,
the heat generator includes a nichrome wire or stainless steel, and
each of the plurality of temperature sensors includes a contact-type thermistor or a thermocouple.

5. The heater according to claim 1, wherein
the hardware processor sets a temperature sensor for thermostatic control on a basis of a temperature measured by each of the plurality of temperature sensors while power is supplied to the planar heat generator by the power supply circuit, and
the hardware processor maintains, in the predetermined condition, a temperature measured by the temperature sensor for thermostatic control at the target value.

6. An inkjet printer comprising:
each of a plurality of ink holders that holds each of a plurality of different colors of ink;
each of a plurality of planar heat generators that is provided on each of the plurality of ink holders and heats each of the plurality of ink holders;
each of a plurality of power supply circuits that controls supply of power to each of the plurality of planar heat generators;
each of a plurality of temperature sensors that is provided on each of the plurality of planar heat generators and measures a temperature; and
a hardware processor that controls each of the plurality of power supply circuits in a predetermined condition to maintain a temperature measured by at least one of the plurality of temperature sensors provided on each of the plurality of planar heat generators at a target value, wherein
each of the plurality of planar heat generators includes:
an insulator; and
a heat generator disposed on the insulator,
the heat generator includes
a plurality of linear parts extending in parallel with each other at a predetermined interval P, and
each of the plurality of temperature sensors is disposed along a direction orthogonal to an extending direction of each of the plurality of linear parts at a position mutually shifted by a predetermined distance D.

7. The inkjet printer according to claim 6, wherein
the hardware processor sets, in each of the plurality of planar heat generators, each of temperature sensors for thermostatic control on a basis of a temperature measured by each of the plurality of temperature sensors at a timing when a predetermined period of time has elapsed since a start of warm-up operation of the inkjet printer or a timing when at least one of a plurality of heaters has reached a predetermined temperature, and
the hardware processor maintains, in the predetermined condition, a temperature measured by each of the temperature sensors for thermostatic control at the target value.
